(19) United States
(12) Patent Application Publication
(10) Pub. No.: US 2006/0168097 A1
(43) Pub. Date: Jul. 27, 2006

(54) Internet radio receiver

(76) Inventor: Stephen Joseph Pittelli, Wellington (NZ)

Correspondence Address: Stephen J. Pittelli, 111 B The Ridgeway, Wellington, NZ

(21) Appl. No.: 10/978,519

(22) Filed: Nov. 2, 2004

(51) Int. Cl. G06F 15/16

(52) U.S. Cl. 709/217

(57) ABSTRACT

A device used specifically to play internet radio stations using a consistent method for interacting with websites, eliminating the need for a full computer with a keyboard, computer screen and/or mouse. The said device is capable of accessing internet radio websites through a wireless modem and basic internet software, playing and/or streaming from these websites using MP3 player software. The said device, using a simple, standardized format to interact with websites, streams the audio information, allowing it to be played through speakers, or an MP3 capable stereo or other electronic device. The said device can choose a particular internet radio station via a control panel, can preload stations and download software from a computer connection and has a rechargeable power source.

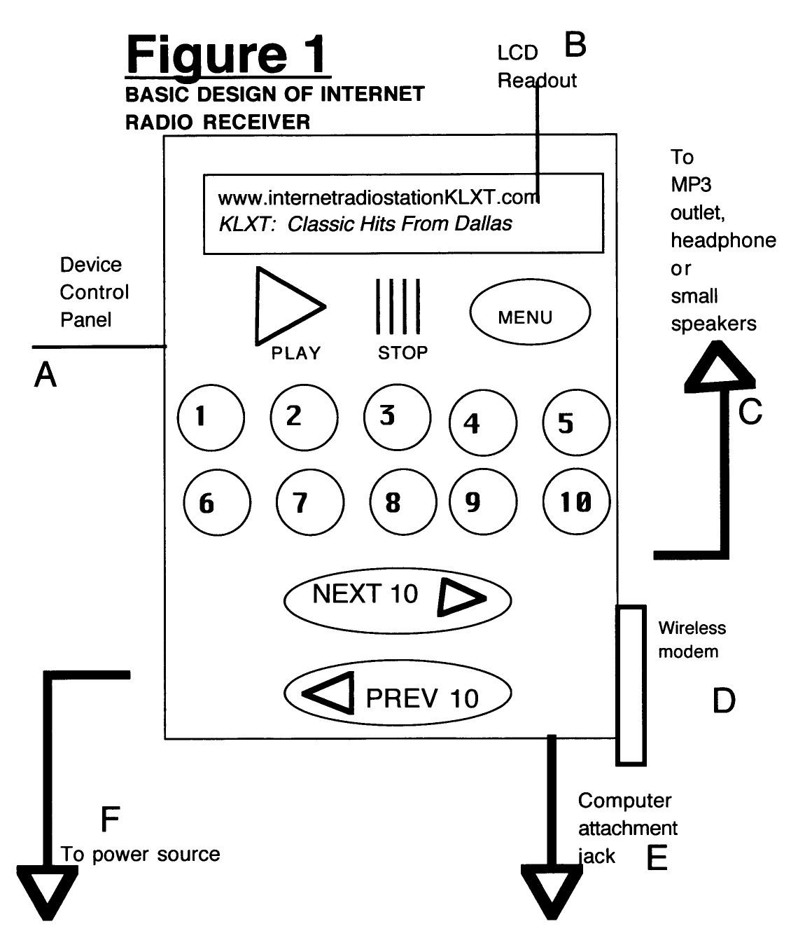

### BACKGROUND OF THE INVENTION

There are thousands of websites currently acting as internet radio stations. Currently, listening to radio stations (or other MP3 based websites) from the internet, whether they be specifically internet stations, websites whose primary purpose is to stream MP3 audio, or regular radio stations that also provide an internet broadcast, it requires a full computer with internet access. When accessing a website for an internet broadcast, each website has its own unique design for beginning a streaming. Thus, one must use a computer with a keyboard and full screen simply to initiate the download streaming. Moreover, to listen to it remotely would require a portable computer with wireless modem access. This is an excessive amount of hardware and is not practical, thus internet radio itself is currently too impractical to use as an exclusive modality.

### BRIEF SUMMARY OF THE INVENTION

By scaling down the “receiver” to its necessary parts, including a wireless modem with some basic internet interaction software capability, a smaller CPU with software capable of playing MP3 through several popular software modalities, and a simple control panel, a person could play any of thousands of preloaded internet radio stations simply by connecting the device to an MP3 jack in a car radio or other stereo device or directly, via headphones or small speakers simulating a portable radio (without a “tuner” equivalent, but with browse-capable, preset stations). The broadcast would be downloaded via the modem and played through the device. This would require a uniform format for websites interacting with the device, which could easily be set up on individual websites (or an adjunct to that current website) now using the internet to broadcast. This format would require little more than the equivalent of pressing the “return” and/or “tab” keys or could involve an automatic download streaming when connecting to the website. Thus, there is no need for a full keyboard, mouse or computer screen and the “stations” could be viewed by browsing through the simple control panel of the device. The device could be used by itself, or as an adjunct to current radios, stereos or other electronic devices such as a cell phone. The internet addresses to various stations could be pre-stored, entered directly from the device or downloaded and arranged from a regular computer to the device with software designed for that purpose.

### DETAILED DESCRIPTION OF THE INVENTION

From the Diagram:

A—Device Control Panel—This is the main area for interacting with the device to play a particular internet radio station. It is used to scan internet radio websites already stored in the device or add new websites.
   Play—Pressing the “Play” button would initiate streaming, whether live or prerecorded for a particular website “station.”
   Stop—Pressing the “Stop” button ends a streaming (this would also be accomplished when changing to a different station)
   Menu—Pressing the “Menu” button allows for other simple options, such as entering a particular website directly and organizing stations.
   Numeric Buttons—These act to simulate using simple radio buttons for preset stations. They can also serve as a data entry keyboard, similar to “texting” on a cellular phone.
   Next 10/Prev 10—These allow the use of the next or previous 10 preset stations (allowing for far more than 10 stations to be preset).
B—LCD Readout—This shows the particular website address for the current internet radio station, as well as a brief description of the station. No other information would be necessary, thus a full computer screen is unnecessary.
C—MP3 Outlet—This allows the Internet Radio Receiver to be attached to an MP3 playing device, headphones or small speakers.
D—Wireless Modem—This allows for an internet connection to a local service provider.
E—Computer Link Jack—This allows (with integrated software) the Internet Radio Receiver to be connected to a regular home computer, to allow scanning, organization and addition of internet radio websites.
F—Power Source—Allows the device (using an adapter) to be plugged in and/or recharged.

All hardware aspects of the device noted in the diagram can be made from materials already in existence. Additionally, software internal to the device to interact with the control panel and internet connection is necessary, as well as software to software interaction with a computer. MP3 player software is already available and could be used as is or with modifications. The primary function of the device, of course, is to perform that function once accessing a formatted website.

1. What I claim as my invention, the “Internet Radio Receiver,” is a portable electronic computer device that specifically and exclusively streams MP3-based websites generally referred to as internet radio stations.

2. I also claim the concept of an Internet Radio Station “Device-Specific Universal Website Format” procedure to be used for websites that wish to act as an internet radio stations also capable interacting with the device that I refer to here as an “Internet Radio Receiver.”

3. I also claim the expanded concept of device-specific universal website formatting procedure to interact with computer devices designed for a specific purpose, that do not require full keyboard and computer screen access in order to perform their basic operations; in other words, a device whose primary purpose is to access multiple websites using the same simple procedure to obtain the data from each website.

4. I also claim the concept of a mimimal internet access computer device that has no need for a computer screen, keyboard or mouse to interact with websites designed from common methods, but whose specific purpose is to allow a download of their information to the device using a universal software format that requires only very limited command interaction to the device, whether that involves rudimentary commands using current internet software or scaled down internet software designed specifically for that purpose.
